(19) United States
(12) Patent Application Publication
(10) Pub. No.: US 2013/0272102 A1
(43) Pub. Date: Oct. 17, 2013

(54) WATCH WITH MULTI-COLOURED COMPONENTS

(71) Applicant: ETA SA MANUFACTURE HORLOGERE SUISSE, Grenchen (CH)

(72) Inventor: Stefan STARK, Preles (CH)

(21) Appl. No.: 13/861,915

(22) Filed: Apr. 12, 2013

Related U.S. Application Data
(60) Provisional application No. 61/623,921, filed on Apr. 13, 2012.

(51) Int. Cl. G04B 45/00

(52) U.S. Cl. CPC G04B 45/0076
USPC 368/238; 29/896.3; 29/896.33

(57) ABSTRACT

Method for forming an assembly of elementary timepiece components, each available in different coloured variants, wherein at least some of said different elementary components are the same colour as each other, characterized in that a random selection of each said elementary component is made until said complete assembly is obtained, so that at least two elementary components are of different colours.

### FIELD OF THE INVENTION

The invention concerns a method for forming an assembly of elementary timepiece components, each available in different coloured variants, wherein at least some of said different elementary components are the same colour as each other. The invention further concerns a method for assembling a timepiece assembly in a given parts list.

The invention further concerns a method for assembling a watch comprising at least a case, a set of hands, and at least one timepiece assembly in a given parts list, including elementary components, each available in different coloured variants, wherein at least some variants of some of said different elementary components are the same colour as each other.

The invention further concerns a watch comprising at least a case, a set of hands and at least one timepiece assembly in a given parts list and comprising elementary components each available in different coloured variants, wherein at least some variants of said different elementary components are the same colour as each other.

### BACKGROUND OF THE INVENTION

In order to obtain a large variety of components, from batches of components available with different looks, it is common to make particular manufacturing batches in set compositions, which has the drawback of placing on the market at a given time similar products which are indistinguishable from each other.

### SUMMARY OF THE INVENTION

The invention proposes to set in place an industrial method for producing multi-coloured watches from components which are each available in several colours or with different looks, so as to create a randomly produced population which does not appear mass produced, and a great variety in the finished products obtained.

The invention therefore concerns a method for forming an assembly of elementary timepiece components, each available in different coloured variants, wherein at least some of said different elementary components are the same colour as each other, characterized in that a random selection is made of each said elementary component until said complete assembly is obtained, so that at least two elementary components are a different colour.

The invention further includes a method for assembling a timepiece assembly in a given parts list, characterized in that a pre-assembly of said timepiece assembly is formed by this type of forming method, and characterized in that said elementary components of said timepiece assembly are mounted in position in a required order.

The invention further concerns a method for assembling a watch comprising at least a case, a set of hands and at least one timepiece assembly in a given parts list, including elementary components each available in different coloured variants, wherein at least some variants of some of said different elementary components are the same colour as each other, characterized in that said at least one timepiece assembly is mounted on said case according to said assembly method, and in that said set of hands is then mounted on said assembled timepiece assembly.

The invention further concerns a watch including at least a case, a set of hands, and at least one timepiece assembly in a given parts list and including elementary components each available in different coloured variants, wherein at least some variants of some said different elementary components are the same colour as each other, characterized in that said case and said set of hands are each a determined colour, and in that all of the colours of all of said elementary components of said at least one timepiece assembly are different, on the one hand from each other, and on the other hand from said determined colours of said case and said set of hands.

### BRIEF DESCRIPTION OF THE DRAWINGS

Other features and advantages of the invention will appear upon reading the following detailed description, with reference to the annexed drawings, in which:

FIG. 1 shows a schematic front view of a watch including at least a case, a set of hands and at least one timepiece assembly in a given parts list and including elementary components.

FIG. 2 shows a schematic view of a control means coordinating a colour recognition means for identifying the colour of each said selected component, storage means for storing the colour of each said selected component, comparison means and an automated manipulator means.

FIG. 3 shows a schematic view of batches of different coloured elementary components, from which components are selected to form a timepiece assembly.

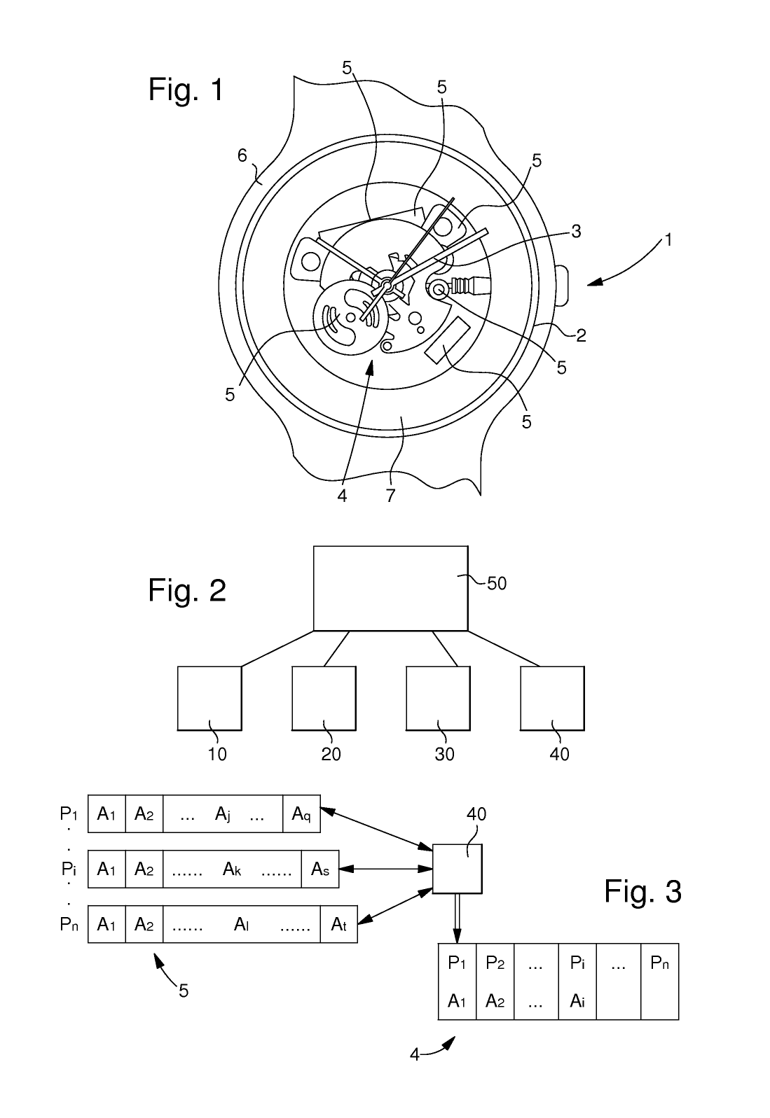

### DETAILED DESCRIPTION OF PREFERRED EMBODIMENTS

The invention proposes to set in place an industrial method for producing multi-coloured watches from components which are each available in several colours or with different looks, so as to create a randomly produced population which does not appear mass produced, and a great variety in the finished products obtained.

“Colour” in the present invention means a particular look, which may be a colour in the usual sense, or which may be linked to the nature of the material, or to a heat and/or surface treatment applied thereto.

The invention concerns a method for forming an assembly 4 of elementary timepiece components 5, each available in different coloured variants, wherein at least some of said different elementary components 5 are the same colour as each other, characterized in that a random selection is made of each said elementary component 5 until said complete assembly 4 is obtained, so that at least two elementary components 5 are a different colour.

According to an alternative implementation of the method, a random selection is made of each said elementary component 5 until said complete assembly 4 is obtained, so that all of the colours of all of said elementary components 5 are different from each other.

According to an alternative implementation of this method:
from among these components 5, a first said component P1 is randomly selected from the population of said colour variants in which said component is available, and the first colour A1 thus selected is stored for said first component P1;
a second said component P2 is randomly selected from among the population of said colour variants in which said component is available, with the exception of said first colour Al selected for said first component P1 and the second colour A2 thereby selected for said second component P2 is stored;
until said total number N of said components Pi is reached, a selection of each other component Pi is made in succession, each from the remaining population of variants whose colour has not already been selected, and the other colour Ai thus selected for said other component Pi is stored;
the process of forming said assembly stops when the composition is complete.

According to an alternative implementation of this method, in order to select another said component 5 from the remaining population of variants whose colour has not already been selected, the following are used:
colour recognition means 10 for identifying the colour of each said selected component,
storage means 20 for storing the colour of each said selected component,
comparison means 30 for comparing the colour of each said selected component to the colours of the previously selected components, to check whether it is different, and to reject it if it is identical to one of said colours, in which case another variant of said other component of the same type is selected, which is subjected to the same comparison test, until a different colour is obtained from the colours of the previously selected components.

According to an alternative implementation of this method, said rejection is performed by redepositing said selected component into a population of the same variant of the same colour as that from which said component was removed.

According to an alternative implementation of this method, at least one automated manipulator 40 is used by control means 50 for selecting each said component of said assembly in a population of the same variant of the same colour, from among several populations each corresponding to a different coloured variant of said same component.

According to an alternative implementation of this method, said control means 50 also controls:
colour recognition means 10 for identifying the colour of each said selected component,
storage means 20 for storing the colour of each said selected component,
comparison means 30 for comparing the colour of each said selected component to the colours of the previously selected components, to check whether it is different, and to reject it if it is identical to one of said colours, in which case another variant of said other component of the same type is selected, which is subjected to the same comparison test, until a different colour is obtained from the colours of the previously selected components.

According to an alternative implementation of the method, said control means 50 includes random control means for randomly removing at least one random variant of said random elementary component.

According to an alternative implementation of this method, said control means 50 includes random control means for randomly removing at least one random variant of said random first elementary component, and completes said composition of said assembly 4 by randomly selecting each said variant of each said elementary component.

According to an alternative implementation of this method, said control means 50 simulates beforehand or in real time the selection of said variants of said elementary components, so as to control simultaneous selections by several automated manipulators 40.

According to an alternative implementation of this method, said control means 50 controls the selection of said variants of said components in a random order.

According to an alternative implementation of this method, said control means 50 controls the selection of said variants of said components in a required order.

The invention further includes a method for assembling a timepiece assembly in a given parts list structure, characterized in that a pre-assembly of said timepiece assembly is formed in accordance with this forming method, and characterized in that said elementary components of said timepiece assembly are mounted in position in a required order.

According to an alternative implementation of this method, at least one automated manipulator 40 is used for selecting each said elementary component 5, and said manipulator also mounts said component 5 in position on a structure 7 comprised in said timepiece assembly 4, either directly or indirectly by assembly on at least one of said other components 5.

According to an alternative implementation of this method, the mounting in position of at least one said elementary component 5 is carried out with a delay relative to the selection thereof.

The invention also concerns a method for assembling a watch 1 comprising at least one case 2, a set of hands 3, and at least one timepiece assembly 4 in a given parts list, including elementary elements 5, each available in different coloured variants, wherein at least some variants of some said different elementary components are the same colour as each other, characterized in that said at least one timepiece assembly 4 is mounted on said case 2 in accordance with said assembly method and in that said set of hands 3 is then mounted on said assembled timepiece assembly 4.

According to an alternative implementation of this method, said case 2 and said set of hands 3 are each selected in a determined colour, and when said at least one timepiece assembly 4 is formed in accordance with the forming method, it is prohibited to select any variant of any component in said determined colour of said case 2 or said set of hands 3.

The invention further concerns a watch comprising at least a case 2, a set of hands 3 and at least one timepiece assembly 4 in a given parts list and comprising elementary components 5 each available in different coloured variants, wherein at least some variants of said different elementary components are the same colour as each other.

According to the invention, said case 2 and said set of hands 3 are each a determined colour, and all of the colours of all of said elementary components 5 of said at least one timepiece assembly 4 are different, on the one hand from each other, and on the other hand from said determined colours of said case 2 and said set of hands 3.

According to a particular feature, this case 2 and set of hands 3 are the same said determined colour.

In a variant, watch 1 also includes a bracelet or wristband 6, the colour of which may, like that of case 2 and set of hands 3, be imposed. Preferably, said bracelet 6, case 2 and set of hands 3 are the same said determined colour.

1. The method for forming an assembly of elementary timepiece components, each available in different coloured variants, wherein at least some of said different elementary components are the same colour as each other, wherein a random selection of each said elementary component is made until said complete assembly is obtained, so that at least two elementary components are of different colours.

2. The method for forming an assembly of elementary timepiece components according to claim 1, wherein a random selection of each said elementary component is made until said complete assembly is obtained, so that all the colours of all the said elementary elements are different from each other.

3. The method for forming an assembly of elementary timepiece components according to claim 1, wherein:
a random selection is made of a first said component from the population of said colour variants in which said component is available, and the first colour thus selected is stored for said first component;
a second said component is randomly selected from among the population of said colour variants in which said component is available, with the exception of said first colour selected for said first component and the second colour thereby selected for said second component is stored;
until said total number of said components is reached, each other component is selected in succession, each from the remaining population of variants whose colour has not already been selected, and the other colour thereby selected is stored for said other component;
the process of forming said assembly stops when the composition is complete.

4. The method of forming an assembly of elementary timepiece components according to claim 3, wherein, to select one said other component from the remaining population of variants whose colour has not already been selected, the following are used:
colour recognition means for identifying the colour of each said selected component,
storage means for storing the colour of each said selected component,
comparison means for comparing the colour of each said selected component to the colours of the previously selected components, to check whether it is different, and to reject it if it is identical to one of said colours, in which case another variant of said other component of the same type is selected, which is subjected to the same comparison test, until a different colour is obtained from the colours of the previously selected components.

5. The method for forming an assembly of elementary timepiece components according to claim 4, wherein said rejection is achieved by redepositing said selected component in a population of the same variant of the same colour as that from which said component was removed.

6. The method for forming an assembly of elementary timepiece components according to claim 1, wherein at least one automated manipulator is used, operated by control means to select each said component of said assembly in a population of the same variant of the samecolour, from among several populations each corresponding to a different coloured variant of said same component.

7. The method for forming an assembly of elementary timepiece components according to claim 6, wherein said control means also controls:
colour recognition means for identifying the colour of each said selected component,
storage means for storing the colour of each said selected component,
comparison means for comparing the colour of each said selected component to the colours of the previously selected components, to check whether it is different, and to reject it if it is identical to one of said colours, in which case another variant of said other component of the same type is selected, which is subjected to the same comparison test, until a different colour is obtained from the colours of the previously selected components.

8. The method for forming an assembly of elementary timepiece components according to claim 6, wherein said control means includes a random control means for randomly removing a random variant of at least one of said random elementary components.

9. The method for forming an assembly of elementary timepiece components according to claim 8, wherein said control means includes a random control means of randomly removing a random variant of at least one said random first elementary component, and completes said forming of said assembly by randomly selecting each said variant of each said elementary component.

10. The method for forming an assembly of elementary timepiece components according to claim 8, wherein said control means simulates beforehand or in real time the selection of said variants of said elementary components, so as to control simultaneous selections by several automated manipulators.

11. The method for forming an assembly of elementary timepiece components according to claim 8, wherein said control means controls the selection of said variants of said components in a random order.

12. The method for forming an assembly of timepiece components according to claim 8, wherein said control means controls the selection of said variants of said components in a required order.

13. The method for assembly a timepiece assembly in a given composition of components, wherein a pre-assembly of said timepiece assembly is formed in accordance with claim 1, and wherein said elementary components of said timepiece assembly are mounted in position in a required order.

14. The method for assembling a timepiece assembly, according to claim 13, wherein, for the selection of each said elementary component, at least one automated manipulator is used which also mounts said component in position on a structure comprised in said timepiece assembly, either directly or indirectly by assembly on at least one of said other components.

15. The method for assembly a timepiece assembly, according to claim 13, wherein at least one said elementary component is mounted in position with a delay relative to the selection thereof.

16. The method for assembling a watch including at least a case, a set of hands, and at least one timepiece assembly in a given parts list structure, comprising elementary components which are each available in different coloured variants, wherein at least some variants of some of said different elementary components are the same colour as each other, wherein said at least one timepiece assembly is mounted on said case according to claim 13, and said set of hands is then mounted on said assembled timepiece assembly.

17. The method for assembling a watch according to claim 16, wherein said case and said set of hands are each selected in a determined colour, and wherein it is prohibited, to select any variant of any component in said determined colour of said case or said set of hands.

18. A watch including at least one case, a set of hands and at least one timepiece assembly in a given parts list structure, and including elementary components, each available in different coloured variants, wherein at least some variants of some of said different elementary components are the same colour as each other, wherein said case and said set of hands are each a determined colour, and wherein all of the colours of all of said elementary components of said at least one timepiece assembly are different, on the one hand from each other, and on the other hand from said determined colours of said case and said set of hands.

19. The watch according to the preceding claim 18, wherein said case and said set of hands are the same determined colour.
